(19) United States
(12) Patent Application Publication
(10) Pub. No.: US 2020/0143504 A1
(43) Pub. Date: May 7, 2020

(54) INTEGRATED GAMING FEATURE CARD

(71) Applicant: Scott Nelson, Willingboro, NJ (US)

(72) Inventor: Scott Nelson, Willingboro, NJ (US)

(21) Appl. No.: 16/671,455

(22) Filed: Nov. 1, 2019

Related U.S. Application Data
(60) Provisional application No. 62/766,704, filed on Nov. 1, 2018.

(51) Int. Cl. G06Q 50/34; G06F 21/62; G06Q 20/40; G07F 17/32

(52) U.S. Cl. CPC G06Q 50/34; G06F 21/6245; G06Q 20/409; G06Q 20/24; G07F 17/3288; G06Q 2220/00; G07F 17/3244

(57) ABSTRACT

An integrated gaming feature device includes a credit card reader, an encryption device for the credit card information, a monitoring device for gaming information, a mechanism for selecting a wager, means for choosing an amount to be wagered, an encryption device for the wager information, means for combining the encrypted wager and credit card information, and an authorization device for transmitting the encrypted wager information to a remote destination.

### BACKGROUND OF THE INVENTION

### 1. Field of the Invention

The present invention relates to devices for placing wagers over communication networks.

### 2. Brief Description of the Prior Art

Wagering on-line has recently expanded significantly with states, such as New Jersey and Pennsylvania, approving placing bets on-line on sports contests as well as enabling remote users to place bets on traditional games of chance. Typically, on-line bets are placed using a client computer connected to the Internet or using a smart phone to enter information relating to the wager. Since all wagers necessarily involve either an actual transfer of money, or a promise to make such a transfer in the future, and because constant threats arise from hackers to the security of client computers as well as smart phones, there can be significant security risk inherent in current on-line gaming systems. Conventional means of secure communication, such as, for example, two-factor authorization schemes, can provide a high level of security and protection against hackers. However, such schemes typically require a significant amount of time for entry of the required information, such as a user name and password, as well as for transmission of a request for a second security factor, the transmission of a response to the request, and entry of the security response by the user. On the other hand, games of chance, as well as multiplayer online games, may offer opportunities for wagering that are very time dependent, at least as perceived by the user. Thus, there is a need for systems that permit users to quickly place on-line bets when a favorable opportunity arises.

### SUMMARY OF THE INVENTION

The present invention provides an integrated gaming feature device permitting a user to quickly make on-line wagers. The device includes a card reader for reading credit card information including the card holder's name, the credit card number, and authentication code. The device preferably includes an encryption device for encrypting credit card information read by the card reader. In one aspect, the device enables the credit card information to be used by the user to purchase digital assets (such as bitcoin) over the internet, and the digital assets can then be used in placing wagers. The device also includes a monitoring unit for monitoring gaming information provided by a remote source, such as by a casino site or a multi-player gaming site. The device also includes a mechanism for selecting a wager in response to the information provided by the remote source. The mechanism preferably generates wager information identifying the wager specifics in response to user input. The device also includes means for choosing an amount to be wagered. The device preferably includes an encryption device for encrypting wager information and the amount to be wagered. The device preferably includes means for combining the encrypted wager information, the amount to be wagered, and the credit card information to provide encrypted wager information. Preferably, the device also includes an authorization device for transmitting the encrypted wager information to a remote destination, such as an on-line casino or multi-player on-line gaming site. In one presently preferred embodiment, the device includes a virtual reality headset. In another presently preferred embodiment, the device includes a game console, such as Nintendo gaming console. In another aspect, the device permits a user to make purchases on-line using the credit card information of real and virtual objects.

### BRIEF DESCRIPTION OF THE DRAWING

FIG. 1 is a block diagram illustrating an embodiment of the device of the present invention.

### DETAILED DESCRIPTION

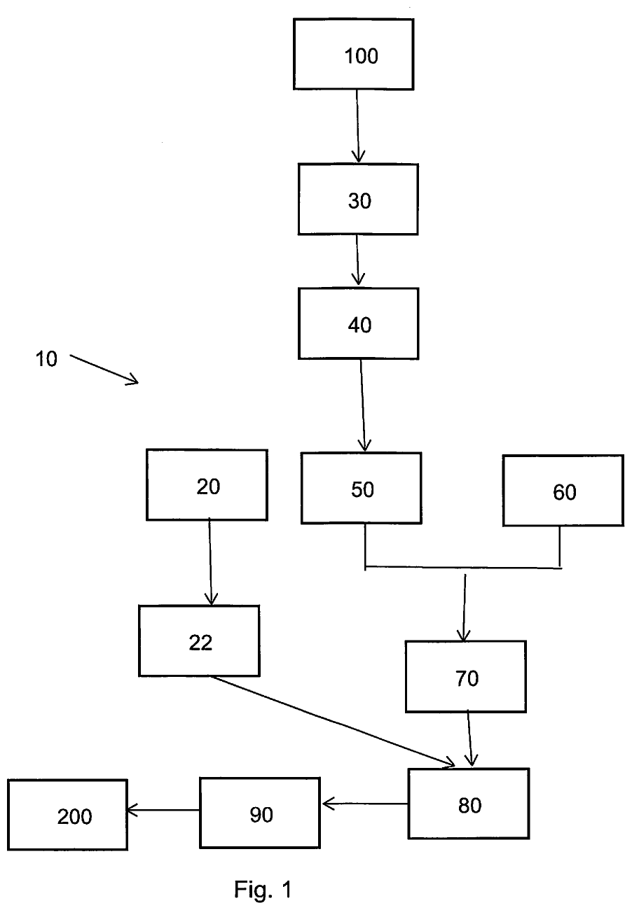

As illustrated in the block diagram of FIG. 1, the present invention provides an integrated gaming feature device 10 permitting a user to quickly make on-line wagers. The device 10 includes a card reader 20 for reading credit card information including the card holder's name, the credit card number, and the authentication code. The device 10 preferably includes an encryption device 22 for encrypting credit card information read by the card reader 10. The device 10 also includes a monitoring unit 30, such as a television, personal computer, or smart phone for monitoring gaming information provided by a remote source 100, such as by an on-line casino site, or a multi-player on-line gaming sites. The device 10 also includes a mechanism 40 for selecting a wager in response to the information provided by the remote source 100. In the alternative, information can be obtained from a remote source such as an on-line gaming platform, which may provide additional or substitute information, such as the odds being offered for a specific outcome in a specific sporting contest by the on-line gaming platform. The mechanism 40 preferably generates wager information identifying the wager specifics 50 in response to user input, such as the specific outcome the user is interested in wagering on. The device 10 also includes means for choosing an amount to be wagered, such as a choice selecting device provided in a virtual reality headset. The device 10 preferably includes an encryption device 70 for encrypting wager information and the amount to be wagered. The device 10 preferably includes means 80 for combining the encrypted wager information, the amount to be wagered, and the credit card information to provide encrypted wager information, such as conventional computer information processing hardware and/or software. Preferably, the device 10 also includes an authorization device 90 for transmitting the encrypted wager information to a remote destination 200, such as a casino betting internet site. In one presently preferred embodiment, the device includes a virtual reality headset. In another presently preferred embodiment, the device includes a game console, such as a Nintendo gaming console.

1. An integrated gaming feature device, the device including:
a card reader for reading credit card information,
an encryption device for encrypting credit card information read by the card reader,
a monitoring device for monitoring gaming information provided by a remote source,
a mechanism for selecting a wager in response to the information provided by the remote source, the mechanism generating wager information identifying the wager specifics in response to user input,
means for choosing an amount to be wagered,
an encryption device for encrypting wager information and the amount to be wagered;
means for combining the encrypted wager information, the amount to be wagered, and the credit card information to provide encrypted wager information, and
an authorization device for transmitting the encrypted wager information to a remote destination.

2. An integrated gaming feature device according to claim 1, the device including a virtual reality headset.

3. An integrated gaming feature device according to claim 1, the device including a game console.
